(19) United States
(12) Patent Application Publication
(10) Pub. No.: US 2020/0027074 A1
(43) Pub. Date: Jan. 23, 2020

(54) SYSTEMS AND METHODS FOR IMPLEMENTING LOCATION-BASED SERVICES

(71) Applicant: MASTERCARD INTERNATIONAL INCORPORATED, Purchase, NY (US)

(72) Inventors: Samy Shihab, St. Charles, MO (US); David J. Senci, Troy, IL (US); Kyle Williams, Wentzville, MO (US); Dhruv Kanwal, Creve Coeur, MO (US)

(21) Appl. No.: 16/037,359

(22) Filed: Jul. 17, 2018

(51) Int. Cl. G06Q 20/32; G06Q 20/38; G06Q 20/40; H04W 4/029

(52) U.S. Cl. CPC G06Q 20/3221; G06Q 20/3224; H04W 4/029; G06Q 20/405; G06Q 20/381

(57) ABSTRACT

Systems and methods are provided for implementing account controls for accounts based on regions in which users associated with the accounts are located. One exemplary method includes receiving location data indicating a location of a communication device associated with an account, where the account is subject to an account control defined in a default currency, and determining a local region of the communication device based on the location data. The method also includes determining a local currency of the local region and converting the account control amount from the default currency to the local currency. The method then further includes notifying a user associated with the account, at the communication device, of the converted account control amount, thereby informing the user of the account control amount in the local currency in connection with transactions to be initiated by the user in the local region and funded by the account.

### FIELD

The present disclosure generally relates to systems and methods for implementing location-based services, and more particularly, to systems and methods for use in utilizing locations associated with communication devices to provide service controls consistent with the locations of the communication devices.

### BACKGROUND

This section provides background information related to the present disclosure which is not necessarily prior art.

It is common for different regions to be associated with different currencies, such that one currency is used in one region and another currency is used in another region. In connection therewith, purchases are known to be facilitated at merchants in the currencies of the regions in which the merchants are located. The currencies are provided in this manner for payment account transactions, where payment accounts used in the transactions are issued in one region and the merchants involved in the transactions are located in another region. As part of such transactions, it is common for currency conversion fees and/or cross-border fees to be applied to the transactions. Separately, for certain payment accounts, consumers are provided controls whereby the consumers may limit the types and/or amounts of transactions to their payment accounts. For example, a consumer may impose a $100 transaction amount limit for his/her payment account, and may receive a notification for all transactions that exceed $20. These example controls allow for monitoring and/or limiting the use of the payment account and/or abiding by budget constraints associated with the consumer and/or the payment account, etc.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in providing a consumer with account controls specific to a currency of a region in which the consumer is located;

FIG. 2 is a block diagram of a computing device that may be used in the exemplary system of FIG. 1;

FIG. 3 is an exemplary method, which may be implemented in connection with the system of FIG. 1, for providing the consumer with the controls specific to the currency of the region in which the consumer is located; and

FIGS. 4A and 4B are exemplary interfaces, which may be displayed to a consumer in connection with the system of FIG. 1 and/or the method of FIG. 3, for use in providing a consumer with account controls specific to a currency of a region in which the consumer is located.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

When consumers impose controls on payment accounts, the limits associated with the controls are typically represented in the currencies in which the consumers are typically transacting for products (e.g., goods, services, etc.). That is, the consumers will often set up the controls in regions of the consumers' residences, which are also often the regions in which the consumers will use their payment accounts to fund transactions. As such, when the consumers cross borders or transition to regions with different currencies, the consumers are left with the task of converting the amounts of the controls to the local currencies in order to avoid attempting transactions in violation of the controls imposed on their payment accounts.

Uniquely, the systems and methods herein provide payment account controls for consumers, whereby the underlying controls are generally reflected in the specific currencies of the regions in which the consumers are typically located (e.g., as default currencies, etc.) but are automatically updated for use in transactions performed by the consumers involving different currencies. In particular, for example, a consumer may opt into a currency conversion service for account controls relating to his/her payment account (where the controls are initially reflected in a default currency for the consumer). Then, when the consumer moves into a region which is associated with a different currency than originally reflected for his/her controls, a controls engine determines that the new currency (e.g., a local currency, etc.) applies to transactions in the region (and also determines that the new currency is different than the original default currency of the payment account). Thereafter, the controls engine converts amounts associated with the account controls to the local currency (e.g., decline transactions above $100 to decline transaction above € 73.87 (based on a current conversion rate), etc.). And, in connection therewith, the consumer is notified about the updated and/or converted account controls amount(s) (e.g., in an application at a communication device of the consumer, etc.). As such, when the consumer intends a purchase transaction in the local region (when different from the consumer's default region), the consumer will be informed of the updated amount(s) for the account controls in a currency consistent with the currency of the purchase (i.e., the local currency), thereby alleviating any need for the consumer to convert the local currency to his/her default currency to evaluate the account controls. In this manner, the account controls are more robust and less confusing to the consumer, are more user-friendly, and are more applicable in different regions.

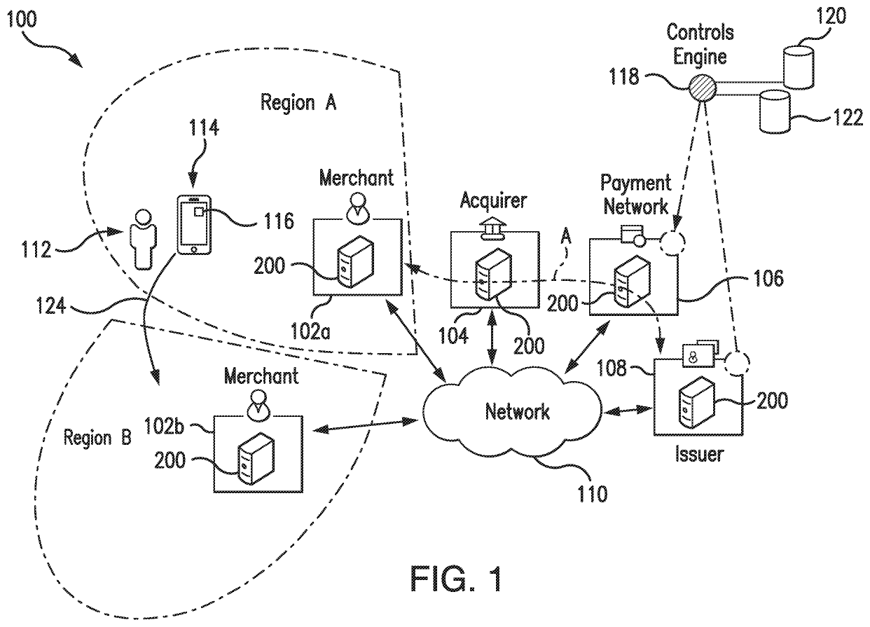

FIG. 1 illustrates an exemplary system 100, in which one or more aspects of the present disclosure may be implemented. Although the system 100 is presented in one arrangement, other embodiments may include the parts of the system 100 (or other parts) arranged otherwise depending on, for example, a number and/or type of merchants included in the system 100, a number of different regions included in the system 100, a manner/flow of processing transactions to an account of a consumer in the system 100, etc.

As shown in FIG. 1, the system 100 generally includes two merchants 102a-b, an acquirer 104 associated with the merchant 102a, a payment network 106, and an issuer 108 configured to issue payment accounts to consumers, each of which is coupled to (and is in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may provide interconnection between the merchants 102a-b, the payment network 106, and other parts of the system 100.

The merchants 102a-b in the system 100 may include any different kinds of merchants, which offer products (e.g., goods, services, etc.) for sale to consumers, including, without limitation, to an exemplary consumer 112, etc. (broadly, a user). As shown in FIG. 1, the merchant 102a is located in Region A, and the merchant 102b is located in Region B. The separate regions may each be defined by any type of geographic or other boundary, such as, for example, a postal code, a county, a province, a state, a territory, a country, etc. Importantly, however, in this exemplary embodiment, Region A is associated with a first currency (currency A), and Region B is associated with a second, different currency (currency B). In this manner, currency A is used to purchase products in Region A, while currency B is used to purchase product in Region B. The currencies for the illustrated regions may be any suitable currency, including, without limitation, the dollar, euro, franc, real, peso, yuan, rupee, yen, dinar, shilling, pound, etc.

In this exemplary embodiment, the consumer 112 is associated with a payment account, which is issued by the issuer 108. The consumer 112 is also associated with a communication device 114, which may include, for example, a smartphone, a tablet, a laptop, etc. In general, in this example, the communication device 114 is a portable device, such that it is carried with the consumer 112 as the consumer 112 travels from location to location (e.g., from Region A to Region B, etc.). And, the communication device 114 is configured, by an application 116, to permit the consumer 112 to impose one or more controls (i.e., account controls) on the payment account associated with the consumer 112. In connection therewith, the consumer 112 may link or associate the payment account with the application 116, for example, at a controls engine 118, etc. And, the account controls may include, for example, a limitation on the amount of a transaction, which causes a notification to be issued to the consumer 112 or a transaction to be declined in the event that the transaction exceeds the certain amount and/or is associated with a particular merchant or category of merchant (e.g., based on a merchant name, a merchant category code (MCC), etc.); generation of a notification for transactions exceeding a certain amount; etc. (e.g., as determined based on transaction data included in data elements (e.g., DE 18 (merchant type), etc.) of authorization requests for the given transactions, etc.). With that said, Table 1 illustrates a number of exemplary account controls and corresponding actions.

TABLE 1

| Account Controls | Implementation/Action |
|---|---|
| Spend Budget | Limit spending to $350 per month for payment account |
| Spend Budget | Limit spending to $50 per month at MCC = 5813 |
| Spend Notify | Text (or email) notification for transaction over $35 |
| Spend Limit | Decline transaction over $150 |
| Spend Limit | Decline transaction over $20 at MCC = 5813 |
| . . . | . . . |

In connection with creating and/or imposing the account controls for the consumer's payment account, the communication device 114, as configured by the application 116, cooperates with the payment network 106 and/or the issuer 108, and/or with the controls engine 118, as describe in more detail below, to permit the consumer 112 to setup, change and/or delete controls for the payment account, as desired.

In connection with the above, the application 116 may include, for example, a payment application (e.g., a virtual wallet, electronic wallet, etc.), which may be used to provide payment account credentials to the merchant 102a for the consumer's payment account, for example, in connection with a transaction by the consumer 112 at the merchant 102a. In such case, the consumer's payment account may be provisioned to the application 116 as appropriate (e.g., by the controls engine 118, etc.). And, the application 116 may be provided by the issuer 108, the payment network 106, or a combination of the issuer 108 and the payment network 106, or otherwise. With that said, it should be appreciated that the application 116 need not be a payment application in some embodiments, whereby the application 116 may instead be a web browser or other application still suitable to configure the communication device 114 as described herein. It should also be appreciated that the consumer 112 associated with the application 116 and/or the payment account (and/or related services) is prompted to agree to legal terms, during installation, enrollment, and/or use of the payment account and/or the application 116, etc. In so doing, the consumer 112 may voluntarily agree, for example, to allow the payment network 106, the issuer 108, etc., to capture data associated with transactions, and/or to allow the application 116 (and/or the communication device 114, for example) to collect and use data to facilitate at least one or more of the different operations described herein.

In an example implementation of the system 100, when the application 116 in the communication device 114 includes a payment application (and when the consumer's payment account is associated with, provisioned to, etc. the payment application), the consumer 112 may initiate an exemplary transaction at the merchant 102a by presenting the communication device 114 to the merchant 102a (acting as a payment device for the consumer's payment account) in connection with purchasing one or more products from the merchant 102a.

In response, the merchant 102a is configured to read or otherwise receive payment account credentials from the communication device 114 for the consumer's payment account (as configured by the application 116) and then to compile an authorization request for the transaction. The authorization request includes, for example, a primary account number (PAN) for the consumer's payment account (or a suitable token), an expiration date for the payment account and/or payment device used in the transaction, an amount of the transaction, a currency code for the transaction, a merchant ID (associated with the merchant 102a), a date/time of the transaction, etc. Once compiled, the merchant 102a is configured to transmit the authorization request to the acquirer 104, along path A in FIG. 1 (where, as indicated above, the acquirer 104 is associated with the merchant 102a to process transactions performed by consumers at the merchant 102a). In turn, the acquirer 104 is configured to communicate the authorization request to the issuer 108, through the payment network 106 (e.g., through MasterCard®, VISA®, Discover®, American Express®, etc.) (again along path A in FIG. 1). The issuer 108 is configured to determine whether the payment account is in good standing and whether there is sufficient credit or funds to complete the transaction, and if approved, to transmit an authorization reply indicating the approval of the transaction back to the acquirer 104 and the merchant 102a, thereby permitting the merchant 102a to continue in the transaction. The transaction is later cleared and/or settled by and between the merchant 102a and the acquirer 104, and by and between the acquirer 104 and the issuer 108 via appropriate agreements. If the issuer 108 declines the transaction, however, the issuer 108 is configured to transmit an authorization reply indicating the decline back to the acquirer 104 and the merchant 102a, thereby permitting the merchant 102a to halt the transaction (or seek alternate funding).

It should be appreciated that while the above exemplary implementation is explained with reference to the merchant 102a, the description similarly applies to transactions involving the merchant 102b (and an acquirer associated with the merchant 102b, be it the acquirer 104 or a different acquirer). That said, as indicated above, further interactions may be imposed and/or required, though, to accommodate the change in currencies and/or regions involving the merchant 102b. This is described in more below.

In addition, while only two merchants 102a-b, one acquirer 104, one payment network 106, and one issuer 108 are illustrated in FIG. 1, it should be appreciated that any number of these entities (and their associated components) may be included in the system 100, or may be included as parts of systems in other embodiments, consistent with the present disclosure. Likewise, it should be appreciated that a different number of regions, consumers, and communication devices may be included in the system 100, or as parts of systems in other embodiments.

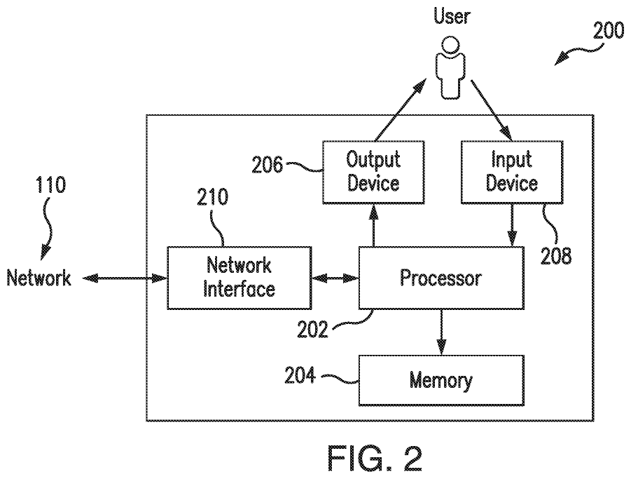

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are configured to function as described herein. In the exemplary embodiment of FIG. 1, each of the merchants 102a-b, the acquirer 104, the payment network 106, and the issuer 108 is illustrated as including, or being implemented in, computing device 200, coupled to the network 110. In addition, the communication device 114 and the controls engine 118 may be considered a computing device consistent with the computing device 200. However, the system 100 should not be considered to be limited to the computing device 200, as described below, as different computing devices and/or arrangements of computing devices may be used.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the operations described herein.

The memory 204, as described herein, is one or more devices that permit data, instructions, etc. to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. With that said, the memory 204 may be configured to store, without limitation, data relating to payment account numbers (e.g., PANs, etc.), currencies per region, currency codes, currency conversion tables, payment account controls, amounts of transactions, country codes (or other location codes), dates/times of transactions, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

In the exemplary embodiment, the computing device 200 also includes an output device 206 that is coupled to (and that is in communication with) the processor 202 (however, it should be appreciated that the computing device 200 could include output devices other than the output device 206, etc.). The output device 206 outputs information, such as, for example, transaction data, currency notifications, account controls notifications, etc., visually or otherwise to a user of the computing device 200, such as consumer 112; etc. It should be appreciated that various interfaces (e.g., as defined by network-based applications (including websites) such as application 116, etc.) (broadly, network-based interfaces) may be displayed at computing device 200, and in particular at output device 206, to display such information. With that said, the output device 206 may include, without limitation, a presentation unit comprising a liquid crystal display (LCD), a light-emitting diode (LED) display, an organic LED (OLED) display, an “electronic ink” display, one or more speakers, etc. In some embodiments, the output device 206 may include multiple devices.

In addition, the computing device 200 includes an input device 208 that receives inputs from the user (i.e., user inputs) such as, for example, inputs regarding account controls, etc. The input device 208 may include a single input device or multiple input devices. The input device 208 is coupled to (and is in communication with) the processor 202 and may include, for example, one or more of a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the output device 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 may include the processor 202 and one or more network interfaces incorporated into or with the processor 202.

Referring again to FIG. 1, the system 100 includes the controls engine 118 and data structures 120 and 122 in communication therewith. The controls engine 118 is configured, by executable instructions, to operate as described herein. And, as shown, the controls engine 118 is a standalone device in the system 100, such as, for example, a computing device consistent with the computing device 200, and is generally in communication with the payment network 106 and/or the issuer 108 (e.g., via network 110 or otherwise, etc.). However, it should be appreciated that the controls engine 118 may be integrated in whole or in part with the payment network 106 and/or the issuer 108, as indicated by the dotted lines. The data structures 120 and 122, in turn, are each coupled to and/or in communication with the controls engine 118. With that said, while the data structures 120 and 122 are illustrated as separate from the controls engine 118 (as separate computing devices 200, for example), it should be appreciated that the data structures 120 and 122 may be incorporated with the controls engine 118, for example, in memory 204 therein, etc. in one or more embodiments. And, when the controls engine 118 is incorporated into the payment network 106 and/or the issuer 108 (or otherwise), the data structures 120 and 122 may likewise be incorporated therewith.

The data structure 120 is configured to store currency data for multiple regions and exchange rates among the currencies for the different regions. In particular for the data structure 120, the currency data, and the exchange rate data included therein, is updated daily, or at one or more other intervals, to provide accurate indications of the currency for each of the different regions and the exchange rate data between the different currencies in one or more of the different regions. The currency data may be organized by currency and/or by region associated with the currency (e.g., by country, etc.). And, the data structure 122 is configured to store location-region data, whereby a location of a communication device (e.g., the communication device 114, etc.) is convertible to a particular region in which the communication device is located, etc. (e.g., Region A, Region B, etc.) (e.g., via a look-up table, etc.). It should be appreciated that the data structures 120 and 122 may include alternate and/or additional data which may be employed separate from, or as a supplement to, the currency data and/or the location-region data described above.

In the illustrated embodiment, the controls engine 118 is configured (via the executable instructions associated therewith) to interact with the application 116 to permit the consumer 112 to add, modify, and/or delete account controls for the payment account associated with the consumer 112 issued by the issuer 108. Additionally, as part of the account controls, the controls engine 118 is configured to solicit the consumer 112 to opt into currency conversion for his/her account controls (e.g., as a currency conversion service offered by the and/or through the controls engine 118, etc.). Specifically, as part of enrollment to and/or installation of the application 116, or in connection with adding or modifying account controls for the consumer's payment account (when already enrolled to the application 116), the controls engine 118 is configured to cause an interface, as part of the application 116 (at the output device 206 of the communication device 114), to solicit the consumer 112 to check a box, initial, or otherwise indicate an opt-in for currency conversion based on location of the communication device 114, in which the application 116 is installed. In response, the consumer 112 either opts into the currency conversion for his/her account controls, or not. In response to the consumer 112 opting into the currency conversion, the communication device 114 and/or the application 116 may issue an application programming interface (API) call to the controls engine 118, or respond to an API call from the controls engine 118, to provide the opt-in of the consumer 112 (whereby the opt-in may be stored in memory at the controls engine 118 in association with a profile for the consumer 112 and/or his/her payment account, application 116, etc.).

When the consumer 112 is opted into the currency conversion for the controls for his/her payment account, the communication device 114 is configured, by the application 116, to transmit location data of the communication device 114 to the controls engine 118, via the network 110, at one or more regular or irregular intervals. The location data may be in the form of a longitude and latitude, an IP address of the communication device 114, or the location data may be in some other format. The format and/or content of the location data may be generalized to inhibit precise location data of the consumer 112 being transmitted to the controls engine 118 (while providing sufficient precision to still accurately determine a region of the consumer 112). What's more, the intervals for providing the location data may be, without limitation, continuously, once daily, hourly, every ten minutes, after some number of miles traveled from a home or last location, upon interaction with the application 116, upon a request and/or inquiry by the consumer 112 (e.g., via the application 116, etc.), etc. Further, the intervals at which the location data is provided may be based on the format of the location data. For example, when the location data includes an IP address, the location data may be provided, by the communication device 114, whenever a new IP address is determined.

In response, the controls engine 118 is configured to receive the location data and to determine, based on the location data and also the location-region data structure 122, a local (or current) region of the communication device 114 (and by approximation, the local region of the consumer 112). The controls engine 118 is configured to then determine if the consumer 112 has entered a different region based on the determined local region and a prior region and/or default region of the consumer 112. When the local region is different from a default region for the consumer 112 (or from a prior determined region for the consumer 112), the controls engine 118 is configured to determine a local currency of the local region, based on the data structure 120, and then to determine if the local currency matches the prior currency or default currency for the account controls for the consumer's payment account. When there is no match, the controls engine 118 is configured to convert, based on the currency data structure 120, the account controls for the payment account of the consumer 112 (e.g., as stored in memory 204 at the controls engine 118, etc.) and to update the account controls with the converted amount and communicate the same to the application 116, so that the consumer 112, when accessing the application 116, is permitted to view an amount(s) associated with the account controls in the local currency.

Finally, the controls engine 118 is configured to notify the consumer 112 that the currency of the amount(s) associated with the account controls is(are) updated. For example, the controls engine 118 may provide a push notification to the application 116 at the consumer's communication device 114 or otherwise transmit a notification to the consumer 112 (e.g., an SMS text message, an e-mail, etc.).

Alternatively, when the consumer 112 decides not to opt into the currency conversion for his/her account controls, the controls engine 118 omits the above operations and proceeds with the given transaction in a conventional manner (whereby the account controls may not be applied based on the difference in currencies or whereby the numeric value associated with the account controls may be applied but in the different currency, etc.).

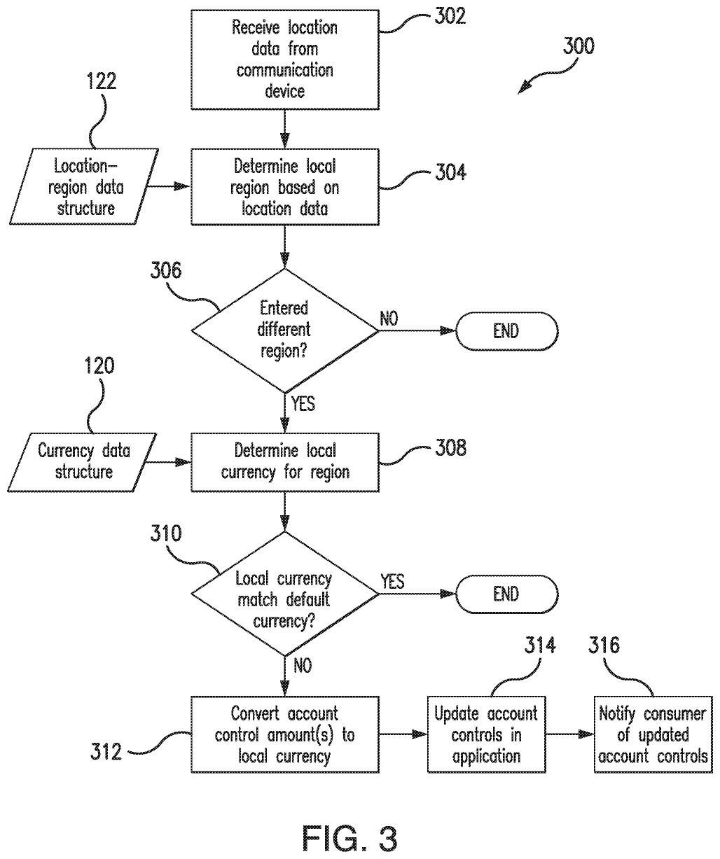

FIG. 3 illustrates an exemplary method 300 for providing consumer account controls for a payment account associated with a consumer, where the controls are specific to a currency of a default region in which the consumer is located, and for implementing the account controls in connection with transactions by the consumer in other regions having different currencies, in the different currencies. The exemplary method 300 is described as implemented in the application 116 and controls engine 118 of the system 100, and further with reference to computing device 200. However, it should be understood that the method 300 is not limited to this configuration/implementation of system 100, as the method 300 may be implemented in other parts (or combinations of parts) of the system 100, or in multiple other computing devices, in other embodiments. As such, the methods herein should not be understood to be limited to the exemplary system 100 or the exemplary computing device 200, and likewise, the systems and the computing devices herein should not be understood to be limited to the exemplary method 300.

In addition, the method 300 is described with reference to the consumer 112 and his/her payment account (as issued to the consumer 112 by the issuer 108). In connection therewith, the consumer 112 is described as residing in Region A in FIG. 1 (as the consumer's home region) (and is located in Region A as a last known location/region), and as imposing (e.g., via input to the application 116 and/or controls engine 118, etc.) an account control on his/her payment account which declines transactions that exceed $150 (where the value of the account control, as set by the consumer 112, is based on the currency of Region A as the default currency). In addition, the method 300 is described with the consumer 112 having opted into currency conversion for the account controls associated with his/her payment account (e.g., via input to the application 116 and/or controls engine 118, etc.), whereby the account controls are updated when the consumer moves to and/or initiates payment account transactions in regions having different currencies than Region A.

With reference to FIG. 3, at some time after, or when the consumer 112 travels from Region A (the consumer's home region) to Region B (as indicated by reference line 124 in FIG. 1), the communication device 114 (via network interface 210) transmits location data to the controls engine 118 (via network 110). In response, at 302, the controls engine 118 receives the location data from the communication device 114. At 304, the controls engine 118 determines (or identifies) a local region for the received location data (i.e., Region B in this example). In doing so, the controls engine 118 may compare the received location data to location definitions of one or more regions within the location-region data of the data structure 122. As an example, when the received location data indicates a longitude of −90° 44′ 55.9212″ and a latitude of 38° 44′ 54.8412″, the controls engine 118 will determine that the communication device 114 is within the location definition of the state of Missouri in the United States, and more specifically, within the region of the city of Winghaven in Missouri. As another example, when the location data includes an IP address, and the controls engine 118 looks up the IP address in an IP address-to-region look-up table and/or reference included in the location-region data structure 122 (e.g., where the look-up table includes multiple IP addresses, each associated with a region; etc.).

Next in the method 300, the controls engine 118 determines, at 306, whether the local region of the consumer 112 (i.e., Region B in this example) is different from a prior region of the consumer 112 (i.e., Region A in this example). This may include, for example, comparing the received location data for the local region to corresponding location data for the prior region and determining if the data is the same, or if the data is in the same zip code, in the same city, in the same county, in the same state, or in the same country, etc. When the local region is the same as or substantially matches (within an acceptable range in the art) the prior region (e.g., when the local region and the prior region are in the same zip code, in the same city, in the same county, in the same state, or in the same country, etc.), the controls engine 118 terminates or ends the method 300 and makes no changes to the consumer's account controls.

However, when the local region is different from the prior region (as determined at 306), the controls engine 118 determines, at 308, the local currency for the local region, i.e., Region B in this example, based on the currency data included in the data structure 120. The controls engine 118 then determines, at 310, whether the local currency is the same as the default currency for the consumer's prior region (i.e., Region A in this example). When the local currency is the same as the default currency, the controls engine 118 terminates or ends the method 300 and makes no changes to the consumer's account controls. But when the local currency is different from the default currency, the controls engine 118 converts, at 312, the currency values associated with the consumer's account controls to the local currency.

In connection therewith, it should be appreciated that such conversion does not actually change the amounts/values of the account controls, it simply converts the amounts/values of the account controls from one currency to another currency. As such, the controls engine 118 maintains the underlying amounts/values of the account controls in the default currency (or currency in which the account controls were originally set) at the controls engine 118, such that the account controls are imposed on subsequent transactions in the default currency despite the location of the communication device 114, for example, being in the local region. In various embodiments, the controls engine 118 only determines the local currency for the local region (at 308) when the local region is different than the default region. In addition, in various embodiments, the controls engine 118 only converts the currency values associated with the consumer's account controls to the local currency when the local currency is different than the default currency. In some embodiments, the controls engine 118 further updates the converted currency values/amounts associated with the consumer's account controls, in the local currency, at predefined intervals (e.g., daily, weekly, etc.), when location data for the consumer 112 indicates that the consumer is still in (or has remained in) the local region, for example, to account for changes in exchange rates between the local currency and the default currency for the consumer's payment account and/or the consumer's corresponding account controls for the payment account.

In the current example, where the consumer 112 moves from Region A to Region B, the controls engine 118 determines, at 308, that currency B is the local currency for Region B (the local region), and then, at 310, determines that currency B is different than currency A, which is the default currency of the communication device 114 and/or the consumer's payment account in home Region A. Because there is a difference between the local currency and the default currency, a conversion is needed. As such, the controls engine 118 converts, at 312, the amount of the consumer's account controls for his/her payment account of $150 (i.e., as represented in currency A) to the local currency of the communication device 114, or euros in this example (i.e., € 120.42). To do so, the controls engine 118 looks up the conversion factor for U.S. dollars to euros, in the data structure 120, and then applies the conversion to the account controls amount of $150, thereby providing € 120.42.

Then in the method 300, once the amounts of the account controls for the consumer's payment account are converted, the controls engine 118 updates (or pushes), at 314, the converted account controls amounts in (or to) the application 116, so that when the consumer 112 views the account controls amounts, the amounts are in the local currency. This may automatically occur when the account controls are updated, or this may occur when the consumer 112 next accesses the application 116. In any case, if the consumer 112 subsequently updates any of the amounts associated with the account controls, while in the local region (such that the updates are in the local currency instead of the consumer's default/home currency) (e.g., via the application 116, etc.), the controls engine 118 receives the updates (from the application 116) and makes/stores the updates such that the modified account controls are in place in the current region. What's more, when the consumer 112 leaves the local region and travels back to the prior home region (or to another region) that involves a different currency than the local currency, the controls engine 118 maintains the updated amounts for the account controls and repeats method 300 (based on the updated amounts). As such, the consumer 112 need not be in his/her home region to modify/change the account controls for his/her payment account.

In addition, the controls engine 118 notifies, at 316, the consumer 112, via the application or otherwise, of the change in/conversion of the amounts associated with the account controls to the local currency. The notification may include, for example, a push notification by the controls engine 118 to the application 116 at the consumer's communication device 114. Or, the notification may include an SMS text message to the consumer's communication device 114 (e.g., depending on consumer settings in a profile for the consumer 112 at the controls engine 118, etc.). In connection therewith, the notification may include a message to the consumer 112 such as, for example, and without limitation, “Your alerts and controls have changed to local currency based on your current location.”

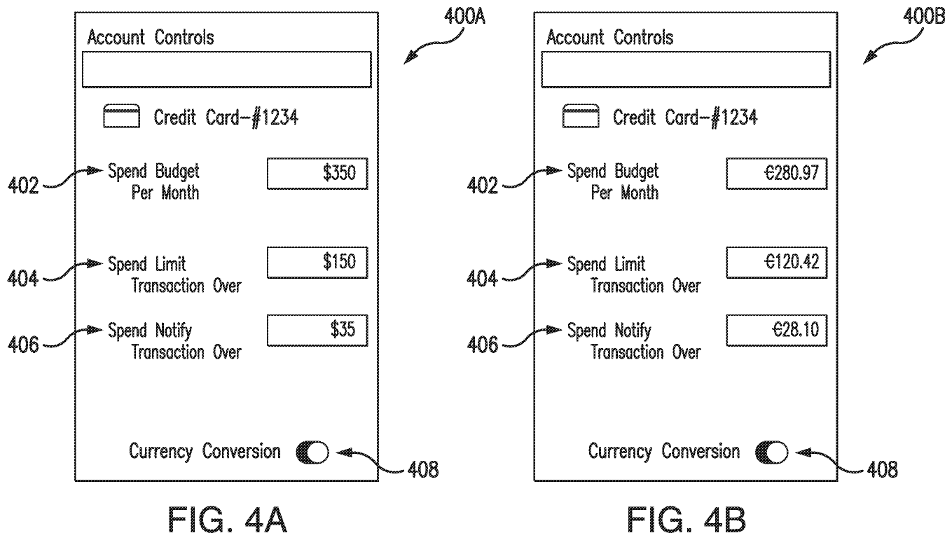

FIGS. 4A and 4B illustrate exemplary interfaces 400A and 400B that may be displayed to the consumer 112 via the application 116 at his/her communication device 114 in connection with providing account controls to the consumer 112 for his/her account. In this example, the consumer 112 has imposed a spend budget control 402 (which limits total spending for the consumer's payment account to $350 per month), a spend limit control 404 (which declines individual transactions to the consumer's payment account for amounts over $150), and a spend notify control 406 (which causes a notification to the consumer for individual transactions over $35). In addition in this example, the consumer 112 has opted into the currency conversion service for the account controls (as indicated by button 408). With that said, interface 400A may be displayed to the consumer 112 (via the application 116) when the consumer is in Region A (e.g., the consumer's home region, etc.) where the values for the account controls are expressed in US dollars (i.e., in the default currency for Region A). And, interface 400B may be displayed to the consumer 112 (via the application 116) when the consumer is in Region B (e.g., the current region for the consumer in the above example, etc.) where the values for the account controls are expressed in euros (i.e., in the local currency for Region A). In some embodiments, the interfaces 400A-B may further include an indication of the current region in which the consumer 112 is located, whereby the consumer may further understand that the account controls are being expressed in a currency for the current region (e.g., interface 400A may further include an indication “Region A” at a location in the interface 400A and interface 400B may further include an indication “Region B” at a location in the interface 400B, etc.).

In connection with the above, if one or more of the account controls are violated, regardless of the region in which the consumer 112 is located (and regardless of the currency being applied by the controls engine 118), the consumer 112 may receive a further notification from the controls engine 118 or from another engine, as is generally conventional, indicating that one or more of the given account controls have been violated and providing details associated therewith (e.g., identifying the particular account control being violated, the particular transaction resulting in the violation and details of such transaction, etc.). Such notification may include, for example, a push notification by the controls engine 118 or other engine to the application 116 at the consumer's communication device 114. Or, the notification may include an SMS text message to the consumer's communication device 114 (e.g., depending on consumer settings in a profile for the consumer 112 at the controls engine 118, etc.).

In view of the above, the systems and methods herein provide location-based payment account controls for consumers, whereby values of underlying controls are reflected in the specific currencies of the regions in which the consumers are presently located. In connection therewith, the consumers may implement the values for the account controls in default currencies of particular default regions, and then view the values in different currencies when the consumers are located in regions associated with the different currencies. As such, the systems and methods herein rely on technology to relay the account controls in the relevant currencies (i.e., in the currencies associated with the regions in which the consumers are presently located), regardless of the fact that the present locations of consumers and/or their communication devices may be different from the default regions. As can be appreciated, this technology provides important notifications of the account controls to the consumers consistent with potential transactions, in advance of the transactions, to thereby permit, aid, etc. the consumers to abide by their account controls regardless of the currencies of the regions of the consumers, and without the consumers having transactions declined due to misunderstandings of the account control amounts in such regions. What's more, the currency conversions of the account controls described herein are transparent to the consumers, whereby the consumers are not required to request control amounts in the local currencies but are instead allowed to simply view the converted amounts in the local currencies in connection with normal operations of accessing their correspond control applications (e.g., application 116, etc.).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more of: (a) receiving location data indicating a location of a communication device associated with an account (e.g., a payment account, etc.), the account subject to at least one account control, the at least one account control based on an account control amount defined in a default currency; (b) determining, by a computing device, a local region of the communication device based on the received location data; (c) determining, by the computing device, a local currency of the local region; (d) converting, by the computing device, the account control amount from the default currency to the local currency, when the local currency is different than the default currency; (e) notifying a user associated with the account, at the communication device, of the converted account control amount for the at least one account control, thereby informing the user of the account control amount in the local currency in connection with transactions to be initiated in the local region and funded by the account; (f) determining that the local region is different than a default region for the account, prior to determining the local currency of the local region; (g) determining that the local currency of the local region is different than the default currency of the account control amount for the account, prior to converting the account control amount; (h) updating, by the computing device, the account control amount in the local currency; (i) maintaining the account control amount in the default currency at the computing device, such that the account control is imposed on a subsequent transaction in the default currency despite the location of the communication device in the local region; (j) transmitting, by the communication device, the location data of the communication device to the computing device; and (k) displaying, at the communication device, the account control amount in the local currency in response to notifying the user of the converted account control amount.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for providing account controls for an account based on a region in which a user associated with the account is located, the method comprising:
receiving location data indicating a location of a communication device associated with an account, the account subject to at least one account control, the at least one account control based on an account control amount defined in a default currency;
determining, by a computing device, a local region of the communication device based on the received location data;
determining, by the computing device, a local currency of the local region;
converting, by the computing device, the account control amount from the default currency to the local currency, when the local currency is different than the default currency; and
notifying a user associated with the account, at the communication device, of the converted account control amount for the at least one account control, thereby informing the user of the account control amount in the local currency in connection with transactions to be initiated in the local region and funded by the account.

2. The computer-implemented method of claim 1, wherein the location data includes a longitude and latitude of a location of the communication device; and
wherein determining the local region of the communication device includes comparing the longitude and latitude of the location of the communication device to location definitions of one or more regions within a location-region data structure associated with the computing device.

3. The computer-implemented method of claim 1, wherein the location data includes an IP address of the communication device in the local region; and
wherein determining the local region includes determining the local region based on a location-region data structure comprising a look-up table for multiple IP addresses, the multiple IP addresses associated with multiple different regions and including an IP address included in the location data.

4. The computer-implemented method of claim 1, further comprising determining that the local region is different than a default region for the account, prior to determining the local currency of the local region; and
wherein determining the local currency of the local region includes determining the local currency of the local region only when the local region is different than the default region.

5. The computer-implemented method of claim 1, further comprising determining that the local currency of the local region is different than the default currency of the account control amount for the account, prior to converting the account control amount.

6. The computer-implemented method of claim 5, wherein converting the account control amount from the default currency to the local currency includes retrieving, by the computing device, exchange rate data from a data structure associated with the computing device and converting the account control amount based on the retrieved exchange rate data.

7. The computer-implemented method of claim 1, further comprising updating, by the computing device, the account control amount in the local currency.

8. The computer-implemented method of claim 1, further comprising maintaining the account control amount in the default currency at the computing device, such that the account control is imposed on a subsequent transaction in the default currency despite the location of the communication device in the local region.

9. The computer-implemented method of claim 1, wherein receiving the location data of the communication device includes receiving the location data from the communication device in response to an inquiry by the user at the communication device.

10. The computer-implemented method of claim 1, further comprising transmitting, by the communication device, the location data of the communication device to the computing device.

11. The computer-implemented method of claim 10, further comprising displaying, at the communication device, the account control amount in the local currency in response to notifying the user of the converted account control amount.

12. A system for use in providing account controls for an account based on a region in which a user associated with the account is located, the system comprising:
a memory having a location-region data structure and a currency data structure, the location-region data structure including region data for identifying a region based on location data, and the currency data structure including currency data for multiple regions and exchange rates among the currencies for the different regions; and
a controls engine processor coupled to the memory and configured, by computer-executable instructions, to:
identify, in the location-region data structure, a local region of a portable communication device associated with a payment account based on location data for the portable communication device, the payment account subject to at least one account control stored in the memory, and the at least one account control based on an account control amount defined in a default currency;
when the local region is different from a default region of the payment account, determine, in the currency data structure, a local currency of the local region;
when the local currency is different from the default currency, convert the account control amount from the default currency to the local currency based on an exchange rate in the currency data structure; and
transmit a notification to a user associated with the payment account, at the portable communication device, indicating the converted account control amount for the at least one account control, thereby informing the user of the account control amount in the local currency in connection with transactions to be initiated in the local region and funded by the payment account.

13. The system of claim 12, wherein the controls engine processor is further configured, by the computer-executable instructions, to update the account control amount in the local currency at one or more intervals.

14. The system of claim 13, wherein the controls engine processor is further configured, by the computer-executable instructions, to maintain the account control amount in the default currency in the memory, after converting the account control amount from the default currency to the local currency, such that the account control is imposed on a subsequent transaction in the default currency despite the location of the portable communication device in the local region.

15. The system of claim 12, wherein the location data is selected from the group consisting of a longitude and latitude of a location of the portable communication device and an IP address of the portable communication device.

16. The system of claim 12, further comprising non-transitory computer-readable storage media including computer-executable instructions, which when executed by the portable communication device, cause the portable communication device to display the account control amount in the local currency in response to the notification from the controls engine processor.

17. The system of claim 16, wherein the computer-executable instructions of the non-transitory computer-readable storage media, when executed by the portable communication device, further cause the portable communication device to transmit the location data of the portable communication device to the controls engine processor.

18. The system of claim 17, wherein the computer-executable instructions of the non-transitory computer-readable storage media, when executed by the portable communication device, cause the portable communication device to transmit the location data of the portable communication device to the controls engine processor in response to an inquiry by the user at the portable communication device.
